(19) United States
(12) Patent Application Publication
(10) Pub. No.: US 2017/0243512 A1
(43) Pub. Date: Aug. 24, 2017

(54) SITUATIONAL PROGRAMMING TEACHING METHOD AND COMPUTER PROGRAM PRODUCT

(71) Applicants: Pai-Tsung LEE, New Taipei City (TW); Kuo-Cheng PARNG, Taipei (TW)

(72) Inventors: Pai-Tsung LEE, New Taipei City (TW); Kuo-Cheng PARNG, Taipei (TW)

(21) Appl. No.: 15/150,473

(22) Filed: May 10, 2016

(30) Foreign Application Priority Data
Feb. 19, 2016 (TW) 105104837

(51) Int. Cl. G09B 19/00; G09B 5/02

(52) U.S. Cl. CPC G09B 19/0053; G09B 5/02

(57) ABSTRACT

A situational programming teaching method and a computer program product are disclosed. The method includes steps of: A. providing an interactive message frame and a virtual object on a screen of an electronic device, wherein the virtual object has a virtual object characteristic which can be modified; B. showing a description of a modification of the virtual object characteristic in the interactive message frame, wherein the modification will be taught later; C. showing codes for modifying the virtual object characteristic in the interactive message frame; D. showing the modification of the virtual object characteristic by the virtual object; and E. showing the codes for modifying the virtual object characteristic in the interactive message frame for learners' further modification. The present invention solves entry barriers for smaller or novice learners in learn programming.

### FIELD OF THE INVENTION

The present invention relates to a programming teaching method and a computer program product. More particularly, the present invention relates to a situational programming teaching method which is able to interact with users and a computer program product using the method.

### BACKGROUND OF THE INVENTION

Today, using programming languages to develop or modify application software is a basic work in many industries. Especially when it comes to a “made-by-robots” era, programming is no longer a course that only college students can take. Promoting programming education (down to elementary schools) has been a consensus of educational policies in many advanced countries. However, for smaller or novice learners, there are many significant barriers for learning programming. First, general programming languages usually use English vocabularies or specific strings as instructions or variables to construct programs. For those who use native language rather than English, it brings them much frustration and low acceptance to learn programming, English vocabularies, or even meaningless strings at the same time. Secondly, programming is logic-oriented. Logic is built based on fully understanding of scenarios of applications. It is another threshold for smaller learners. In addition, for many object-oriented programming languages, there are lots of interfaces, and even hardware connected, should be taken into consideration during programming. Applications of interfaces ranges from abstract images to real entities. Even after numbers of implementations, learners are still difficult to comprehend the skills quickly. Therefore, there are always problems bothering smaller or novice learners and making teaching programming ineffective.

In addition to traditional textbooks and courses for learning programming, there are more and more ways to learn programming, recently. Learners can surf web sites, watching videos pre-recorded in advance by the teachers. Screenshots are embedded in the videos. Learners can understand the codes and executed results synchronously. Thus, time to learn programming can be reduced. Learners are able to review the sections where the content is not comprehended again and again. A more advanced way for learning programming is to down APPs in the tablet or smartphone. The APPs provide materials to teach programming, anytime and anywhere. This way is different from watching videos. Since a screen of the tablet or smartphone is not large, contents of learning should be divided into many sections. Learners should operate the APP in separate windows and different courses, slowly accumulating their achievements. In general, these programming learning APPs have the contents divided according to syntaxes and instructions. Some of the APPs also provide integrated cases for reference. It is convenient for people who are determined to learn programming. However, the problems mentioned above are still pending for solutions. It helps less for smaller and novice learners.

Situational learning, as the name suggested, is to learn real operations by observation, communication and interaction in a field. In many teaching fields, situational learning has excellent effects. It is pity that there are no related applications and inventive achievements in teaching programming. The present invention is to introduce situational learning in teaching programming and provide the result from research and development.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

In order to settle the problems mentioned above, a situational programming teaching method is disclosed in the present invention. The method includes steps of: A. providing an interactive message frame and a virtual object on a screen of an electronic device, wherein the virtual object has a virtual object characteristic which is capable of being modified; B. showing a description of a modification of the virtual object characteristic in the interactive message frame, wherein the modification will be taught later; C. showing codes for modifying the virtual object characteristic in the interactive message frame; D. showing the modification of the virtual object characteristic by the virtual object; and E. showing all or partial codes for modifying the virtual object characteristic in the interactive message frame for learners' further modification.

According to the spirit of the present invention, the method further includes a step: F. showing the further modification of the virtual object characteristic by the virtual object.

According to the spirit of the present invention, the method further includes a step A1 after the step A and a step F1 after the step E: A1. providing a physical object, wherein the physical object is independent from the electronic device, wirelessly linked to the electronic device and controlled by the electronic device, and has a physical object characteristic corresponding to the virtual object characteristic; and F1. showing changes of the physical object characteristic corresponding to the further modification of the virtual object characteristic by the physical object.

Preferably, the electronic device may be a laptop computer, a tablet or a smartphone. The virtual object may be a single image of the physical object, successively captured images of the physical object, a single schematic image, or successively schematic images. The modification description may be a textual explanation for codes modifying corresponding virtual object characteristic. A situational guiding object may be further provided in the step A. The situational guiding object shows a display aspect and changes to another display aspect as a message shown in the interactive message frame changes. The display aspect may be a single schematic image or successively schematic images.

In addition, an aspect of the present invention is a computer program product for situational programming teaching. The computer program product is installed in an electronic device having a screen, executing for carrying out the method mentioned above.

The present invention utilizes the situational guiding object and text changes in the interactive message frame to let learners comprehend scenarios of applications and understand the logic in programming quickly. Meanwhile, the interactive message frame can let learners be familiar with specific syntaxes, words and parameters with repeated practices. It makes those who don't use English as the native language gradually get skilled about the specific vocabularies or strings used in programming. Last, the interface to execute codes is simplified. Learners won't be afraid of applications of interfaces from abstract images to real entities.

### BRIEF DESCRIPTION OF THE DRAWINGS

FIG. 1 is a flow chart of a situational programming teaching method according to the present invention.

FIG. 2 to FIG. 14 are schematic diagrams of an interface of an APP using the situational programming teaching method in operation.

### DETAILED DESCRIPTION OF THE PREFERRED EMBODIMENTS

The present invention will now be described more specifically with reference to the following embodiments.

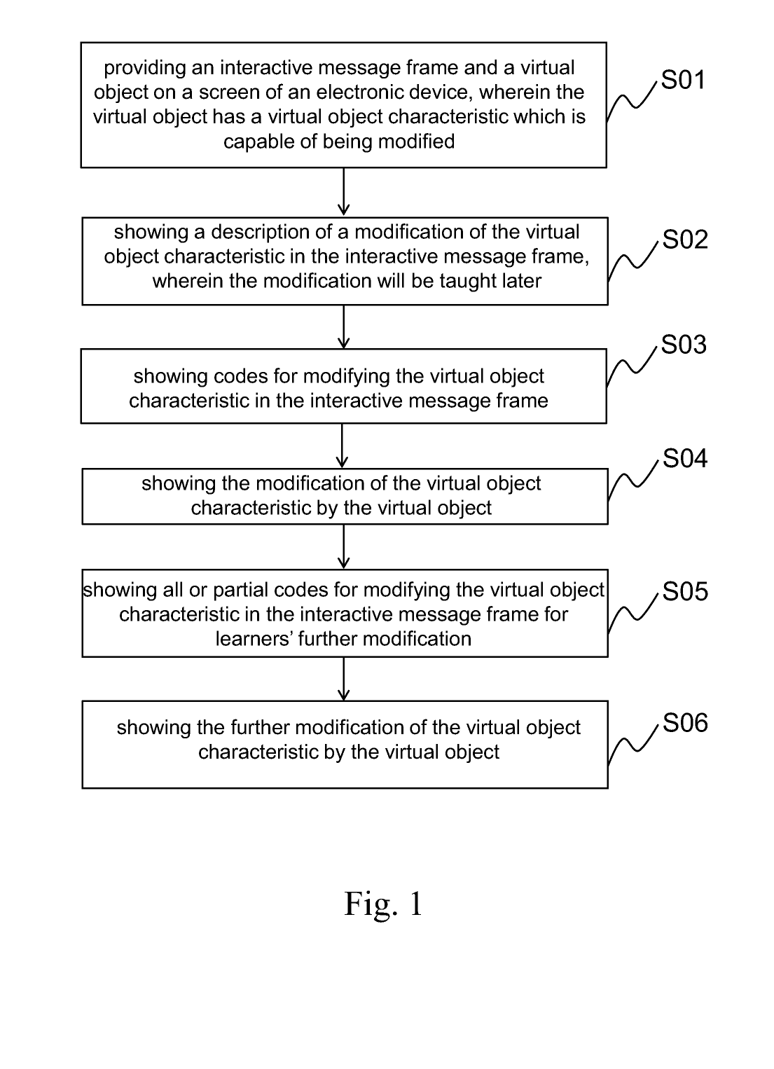

Please refer to FIG. 1. It is a flow chart of a situational programming teaching method disclosed by the present invention. Before the situational programming teaching method is further illustrated, it is noticed that the programming languages used are limited by the present invention. However, for better utility, object-oriented programming languages are preferred. There are many object-oriented programming languages in the world developed and widely accepted by people, for example, JAVA, Objective C, C#, LIVECODE . . . etc. They are all applicable programming languages for the present invention. Since one key point of the present invention is to provide a ‘situational programming teaching’ so that smaller or novice learners are able to accept contents of the programming courses quickly and willing to learn, a fourth generation of the programming languages, which has natural grammar (Namely, the codes use normal texts and are close to spoken dialogue. People can intuitively understand what meaning the codes stand for.), e.g., LIVECODE, is a preferred programming language. In the embodiments below, all teaching contents are illustrated by the codes of LIVECODE.

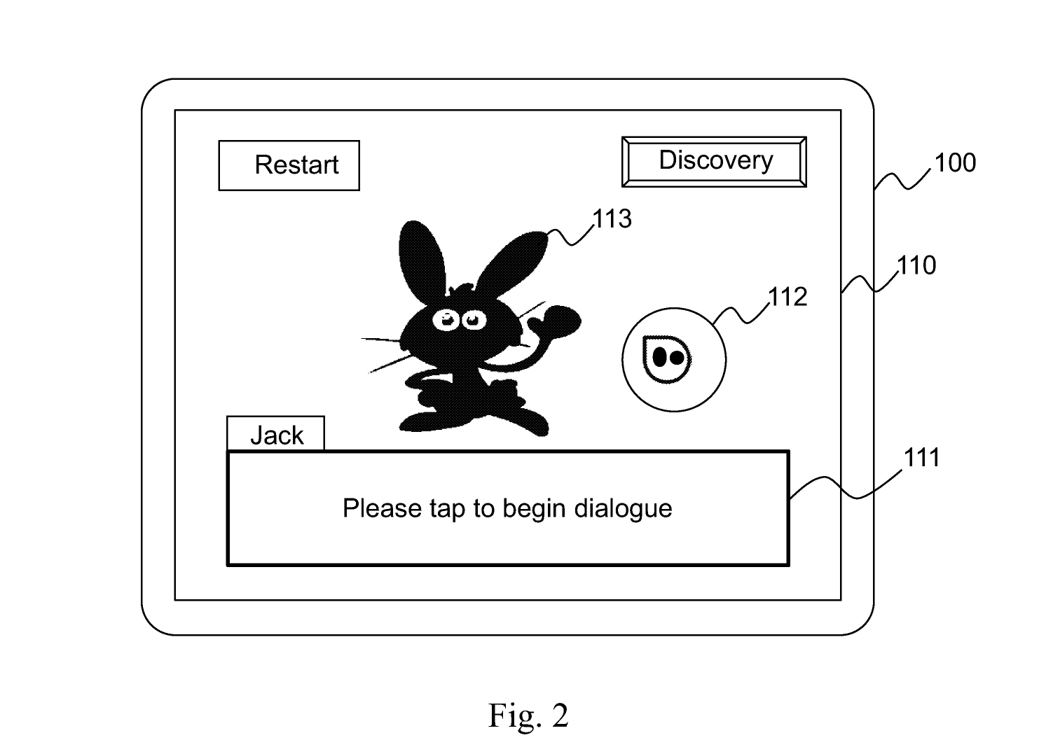

First, the situational programming teaching method according to the present invention is to provide an interactive message frame and a virtual object on a screen of an electronic device. The said virtual object has a virtual object characteristic which is capable of being modified (S01). To help illustrate, please see FIG. 2. The present invention is embodied by installing a computer program product in the said electronic device to operate. The electronic device mentioned here may be a laptop computer, a smartphone, or a tablet 100 shown in FIG. 2. Of course, the electronic device can also be a customized hardware having an interactive screen and designed for programming education. Since it is operated by the tablet 100, the computer program product is an APP. After the APP is executed, a touch screen 110 shows an interactive message frame 111 and a virtual object 112. The interactive message frame 111 can show dialogues corresponding to the teaching situation and contents of programming teaching, such as codes. Learners can carry on interactive learning through the touch screen 110 by modifying some codes which are allowed to modified.

In this embodiment, the virtual object 112 is an emitting ball which is able to emit lights in all colors and used to show the effect (emit lights in a specific color) of demo codes or of the codes modified by the learners. Of course, the virtual object 112 is not limited to the emitting ball. In another embodiment, the virtual object 112 may be an audio equipment. It can be controlled by different codes and play individual songs; The virtual object 112 can also be a toy robot, receiving different codes to act in different way. For different courses applied, the virtual object 112 has different looks. It is not limited by the present invention. However, the virtual object 112 must have a virtual object characteristic which can be modified. The virtual object characteristic can be changed according to specific codes. For example, the colored lights, different songs and actions of the robot are all of the virtual object characteristic.

In FIG. 2, the APP will show other objects on the touch screen 110, such as a ‘restart’ button, a ‘Discovery’ button, a situational guiding object 113, and an illustrative frame for the situational guiding object (a frame shows the name ‘Jack’ for the situational guiding object 113 in FIG. 2), after being executed. For the present invention, the most important one among these objects is the situational guiding object 113. The situational guiding object 113 is able to show one display aspect and change to another display aspect as a message shown in the interactive message frame 111 changes. In this embodiment, the situational guiding object 113 is a rabbit image. The situational guiding object 113 will show different action or facial expression (display aspect) as different messages are shown. It can lead the learners into the scenario (or situation) of the curriculum of programming learning. The situational guiding object 113 can also be an unchanged background (the display aspect is a single schematic image). However, it will cause bad learning results. Of course, the display aspect may be successively schematic images, or successively schematic images with changed background music. Thus, the learning result is the best.

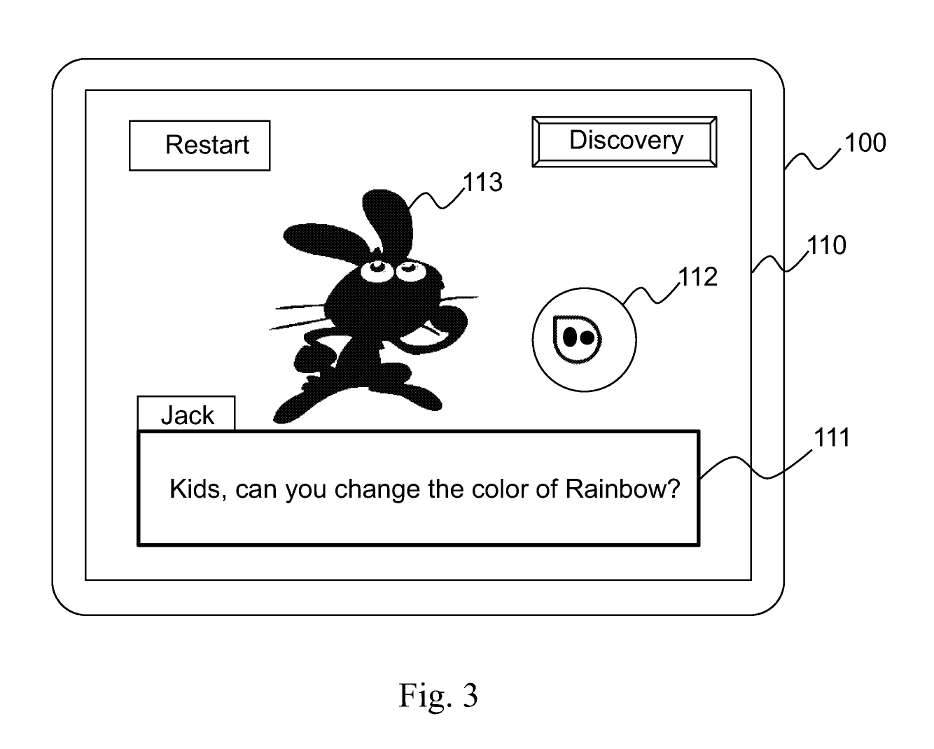

In the interactive message frame 111 of FIG. 2, it shows ‘Please tap to begin dialogue’ to guide a learner to start learning programming. After the learner taps the interactive message frame 111, the picture changes to the one in FIG. 3. It is clear from FIG. 3 that the picture shown on the touch screen 110 has two changes: shape of the situational guiding object 113 changes and displayed message in the interactive message frame 111 changes to ‘Kids, can you change the color of Rainbow?’. The rule of change for the former has been described previously. It is not to repeat again. Since the interactive message frame 111 updates the wording, the learner is gradually familiar with the scenario of the curriculum. With the cognition of the task, the learner can have further understanding about the contents of programming to be learned in the coming stages.

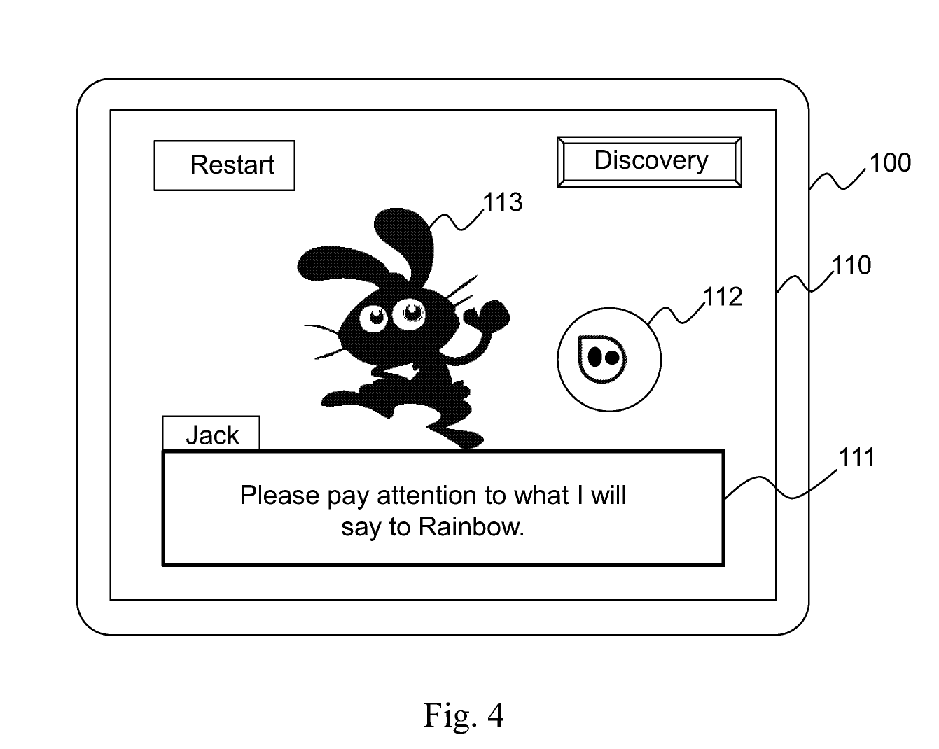

Next, a second step of the present invention initiates: showing a description of a modification of the virtual object characteristic in the interactive message frame 111. The modification will be taught later (S02). Here, the modification is the emitting way of the emitting ball (virtual object 112) offered to the learner. Thus, the picture on the touch screen 110 further changes to the one in FIG. 4. The wording shown in the interactive message frame 111 changes to ‘Please pay attention to what I will say to Rainbow’

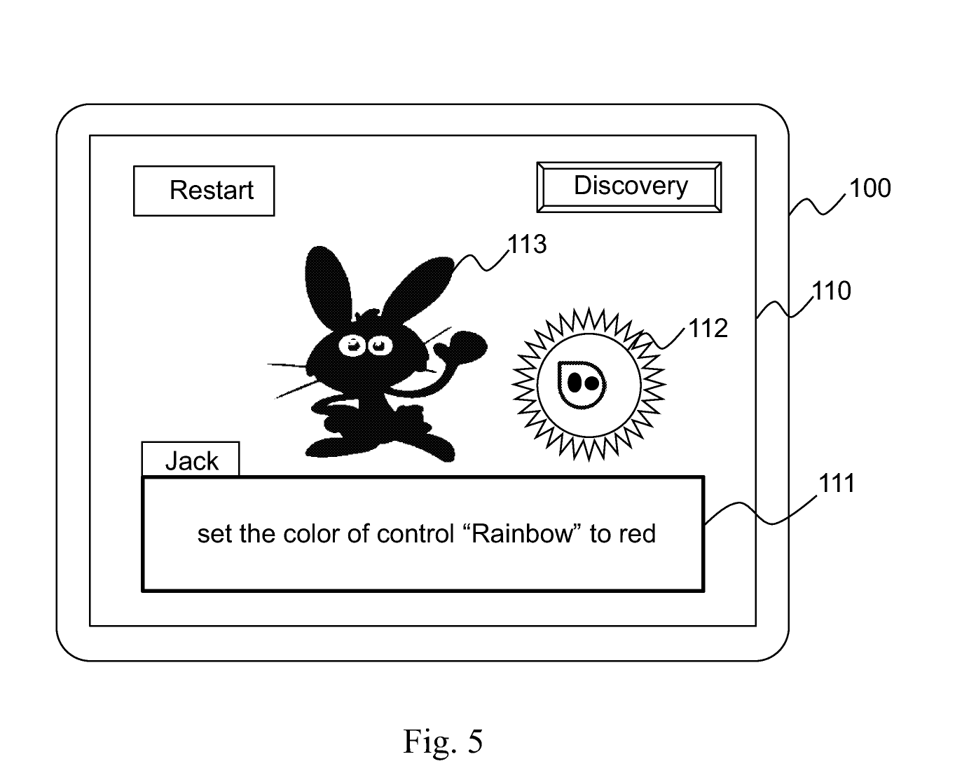

Next, show codes for modifying the virtual object characteristic in the interactive message frame 111 (S03). Please see FIG. 5. The interactive message frame 111 shows the codes which make the emitting ball (virtual object 112) to emit red lights: ‘set the color of control “Rainbow” to red’ (Rainbow is the name of the object, the emitting ball). At the same time or later, the emitting ball (virtual object 112) on the touch screen 110 changes from no light to emitting red lights. It is to show the modification of the virtual object characteristic by the virtual object (S04). Here, some features of the present invention should be emphasized. First, since it is used for situational teaching, the codes should be as short as possible so that the way the main instruction or variables are used can be pointed out. However, those who are in the art of programming all know that it is not possible to control changes of an object with only one line of codes. Only the picture of the touch screen 110 needs more than one interfaces and control logic. It is not to mention the control of other elements in the interface. Therefore, the present invention is to take a whole set of codes as an input and show the corresponding action on the touch screen 110. In other words, in order to change the line of codes into a real operation of the virtual object 112, there should be many other codes in the background of the APP to work with. It can not be seen by the learner. However, the corresponding technique, receiving a wording (the line of codes) to change an image in an interface, can be achieved by conventional programming skills and not the key point of the present invention. Secondly, the content of said codes can be read close to what is used in the dialogue. It is an advantage to use programming language with natural grammar in the present invention. After comprehending the scenario of the application, corresponding codes can be memorized. It speeds up learning of programming for the smaller or novice learners.

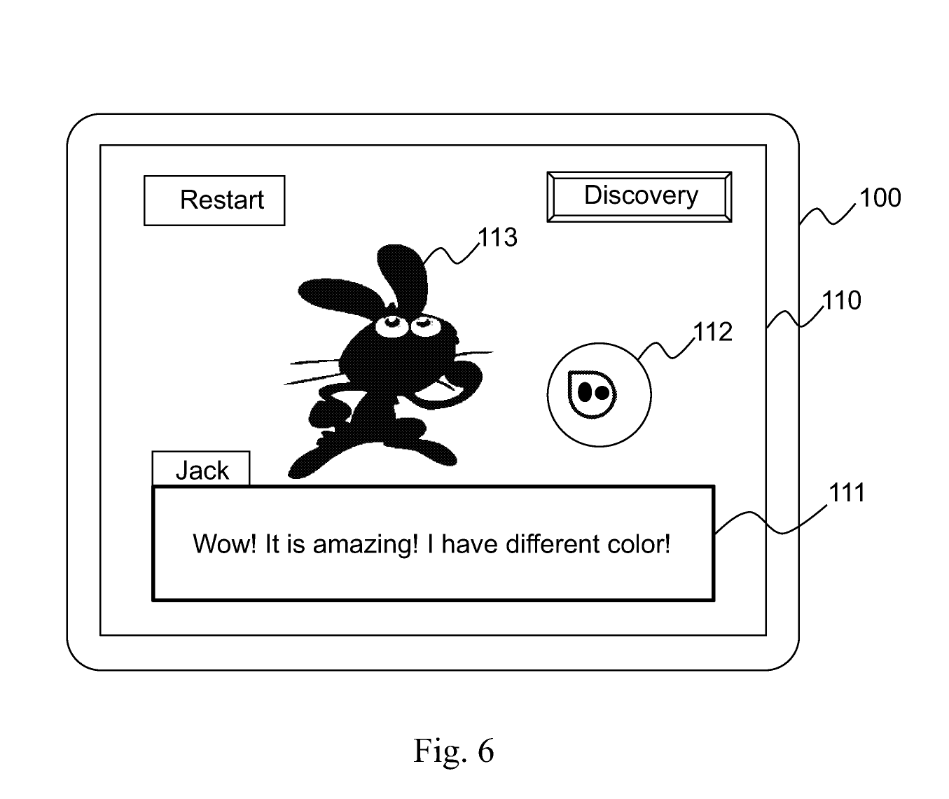

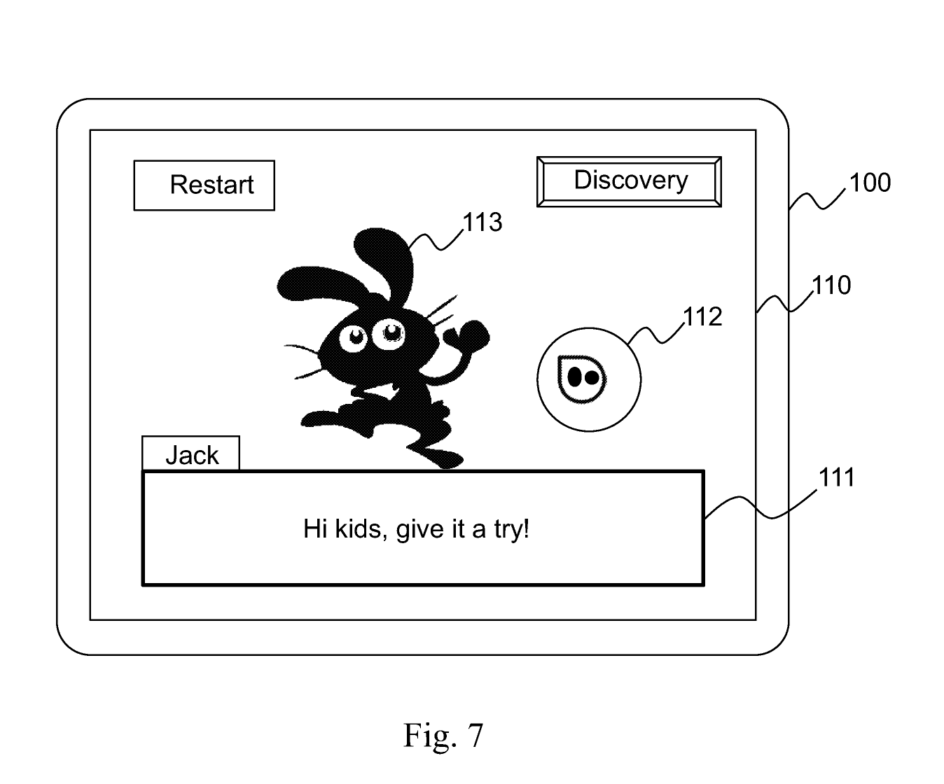

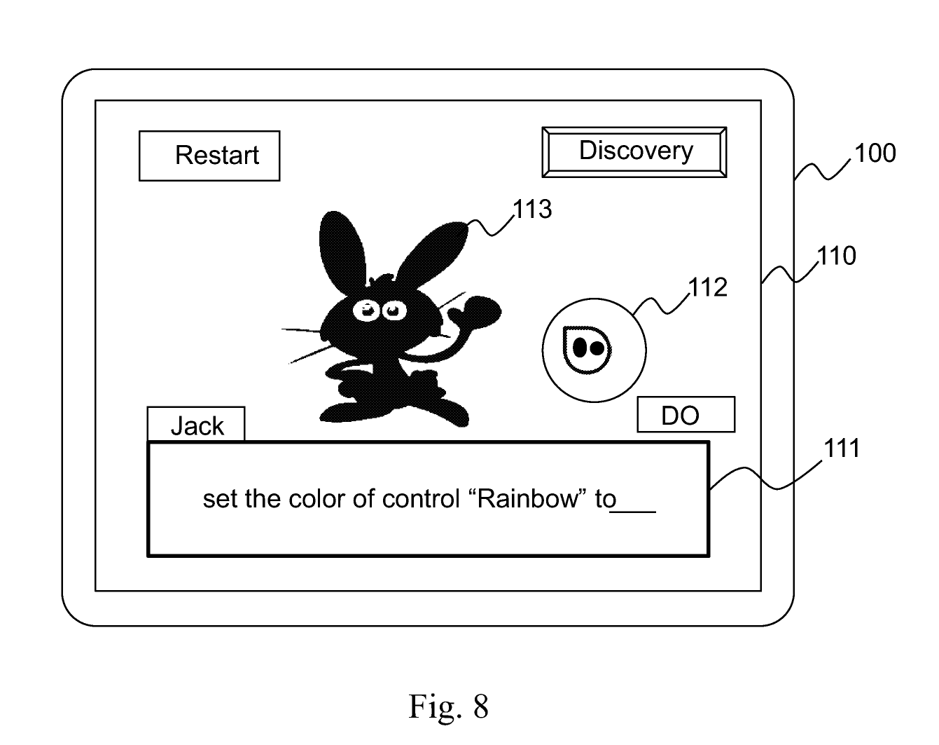

After learning a number of codes, it is time to let the learner to practice. The picture changes from the text guiding in the interactive message frame 111 in FIG. 6 and FIG. 7 into a next stage. According to the present invention, it is to show all or partial codes for modifying the virtual object characteristic in the interactive message frame 111 for the learner' further modification (S05). Please see FIG. 8. The APP will hide syntax(es), key word(s) and/or parameter(s) in the codes and ask the learner to key in the correct one(s). The learner can follow the teaching material shown earlier and fill in ‘red’ in the blank. He can also try other parameters, e.g. blue, to see if there are any other changes. It should be emphasized that the hidden syntax, key word and parameter are the key points in the teaching. The parts need to be memorized by the learner should act in concert with the virtual object characteristic of the virtual object 112. If a syntax which has nothing to do with color change is hidden, even the learner keys in the correct answer, the final result is unrelated to the scenario and inconsistent with the purpose of the present invention.

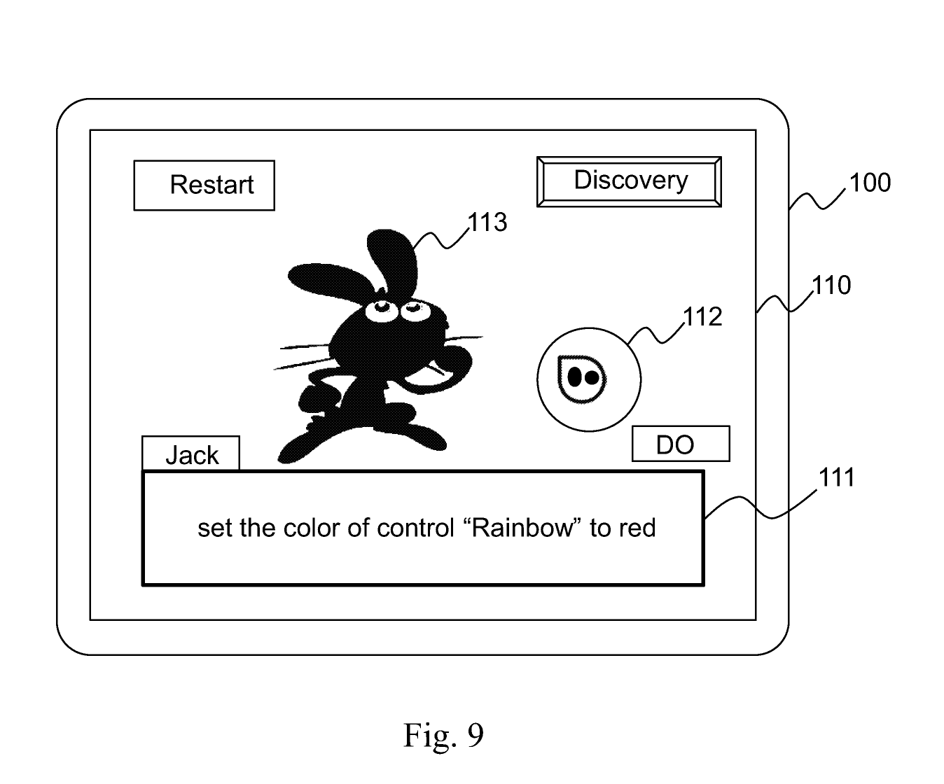

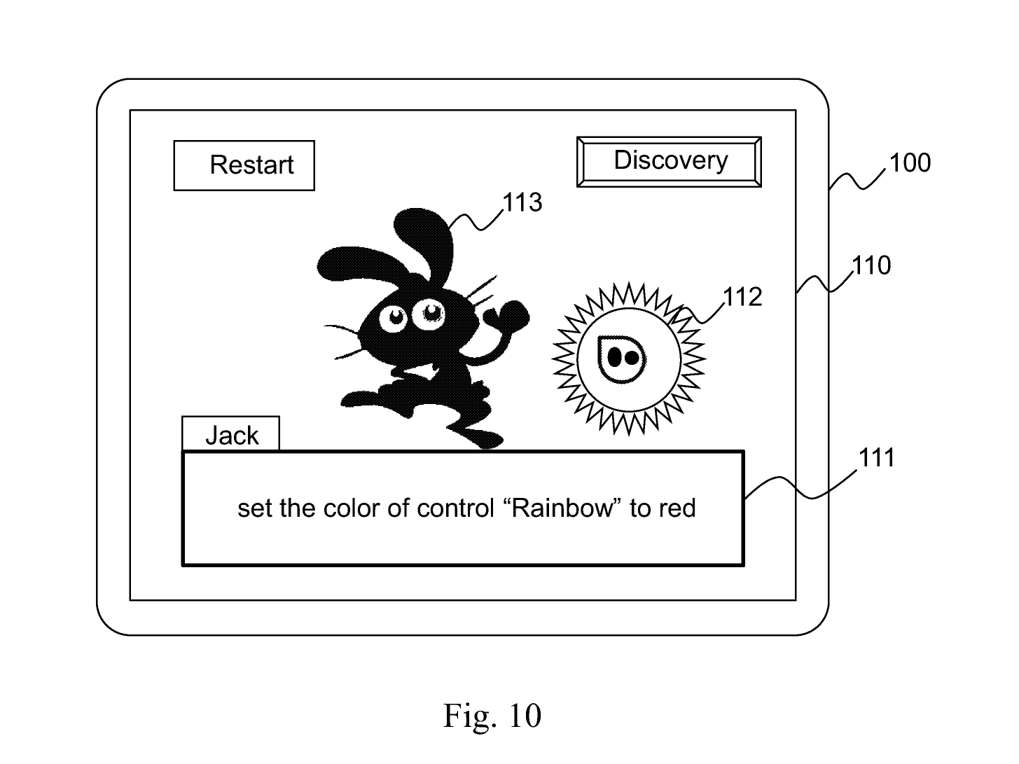

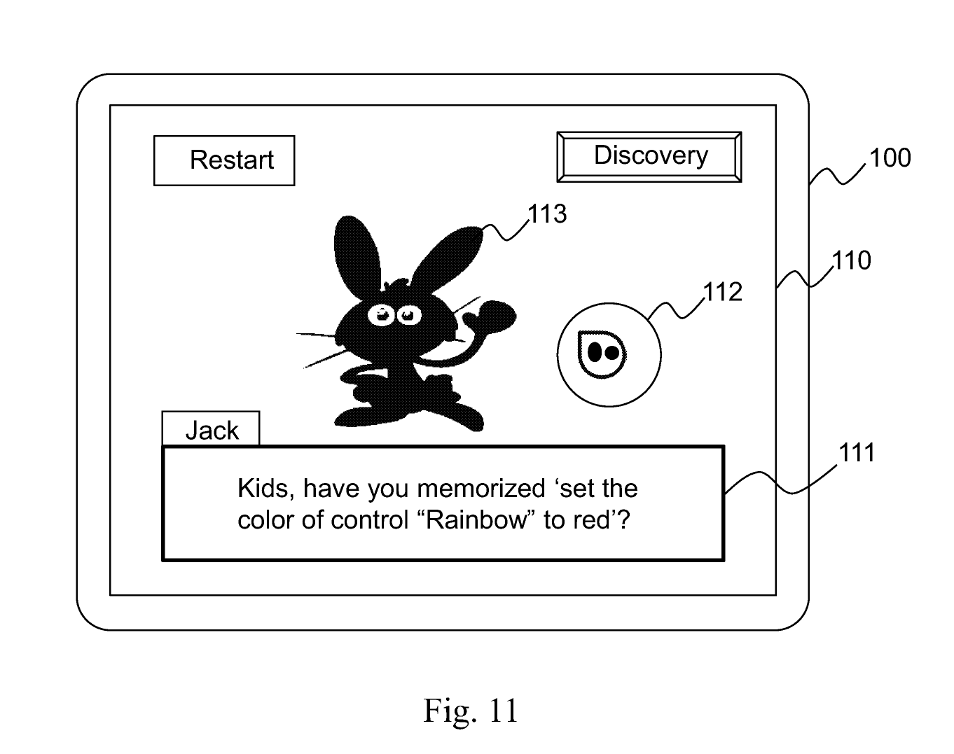

Finally, show the further modification of the virtual object characteristic by the virtual object 112 (S06). It can be done by tap the emerging executing frame (the frame of ‘DO’). As the one shown in FIG. 9, if ‘red’ is keyed in, the emitting ball (virtual object 112) emit red lights; if ‘blue’ is inputted, the emitting ball can emit blue lights (predefined). If the inputted parameter is not defined, for example the input of ‘fly’, the message in the interactive message frame 111 may show ‘You have incorrect input. Please try it again.’; the interactive message frame 111 may have no response until the correct parameter is keyed in. And then, the corresponding modification or the virtual object characteristic will be carried out and the processes end. The displayed message can very according to different designs. At the end of a period of learning, the message in the interactive message frame 111 may be the wording, as shown in FIG. 11, ‘Kids, have you memorized ‘set the color of control “Rainbow” to red‘?’. It is used to inspire smaller and novice learners in learning programming.

In another embodiment, the application of the present invention can extend to a physical object. It is to use codes to control changes of the physical object. By this way, learners will have more fun in learning programming. A specific practice is to add a new step between step S01 and step S02: provide a physical object 200, which is independent from the tablet 111 (electronic device), wirelessly linked to the tablet 111 (electronic device) and controlled by the tablet 111 (electronic device). The physical object 200 has a physical object characteristic corresponding to the virtual object characteristic. The physical object 200, cooperated with the emitting ball (virtual object 112), is a physical lighting ball. The physical lighting ball can be deemed as an application of IOT (Internet Of Things). By wirelessly setting the tablet 111, e.g. Bluetooth or Wi-Fi, and specific codes, the physical lighting ball can be controlled. Here, the physical object characteristic is the changeable colors of the physical object 200 and the virtual object characteristic is the changeable colors of the virtual object 112. As mentioned above, only one line of codes on the touch screen 110 is not able to control lighting of the physical lighting ball. There must be numerous hardware control programs working with the logic of the APP in its background to finish the job. Control of hardware is not a special technology. Anyone who is familiar with hardware control can work out a solution according to a specific architecture of hardware. It is not emphasized by the present invention.

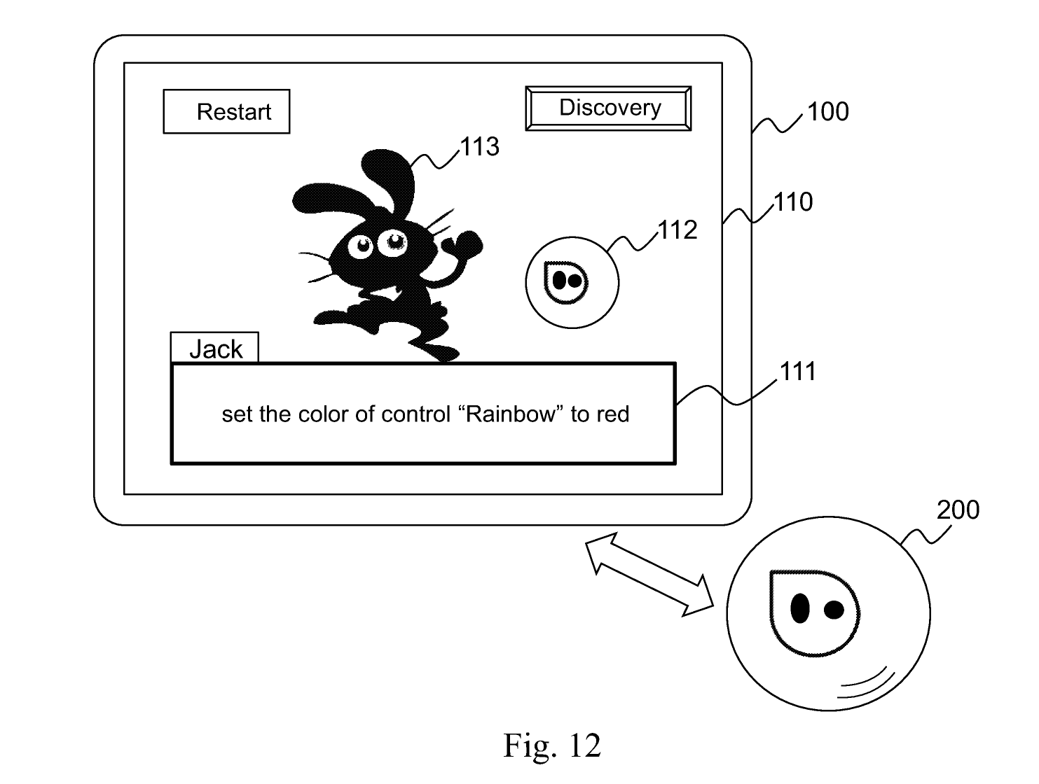

As described in the previous embodiment, after step S02 to step S05 are completed, the learner can finish learning codes and operation of simulation on the touch screen 110 of the tablet 111. According to the spirit of present invention, it is now to demo the real application of the codes by the physical object. Therefore, the original step S06 should be modified as: show changes of the physical object characteristic corresponding to the further modification (the emitting ball emits) of the virtual object characteristic by the physical object 200 (physical lighting ball). Namely, the physical lighting ball lights. As shown in FIG. 12, when the learner inputs correct parameter and tap the executing frame, the emitting ball will not change. A new change is that the physical lighting ball lights red.

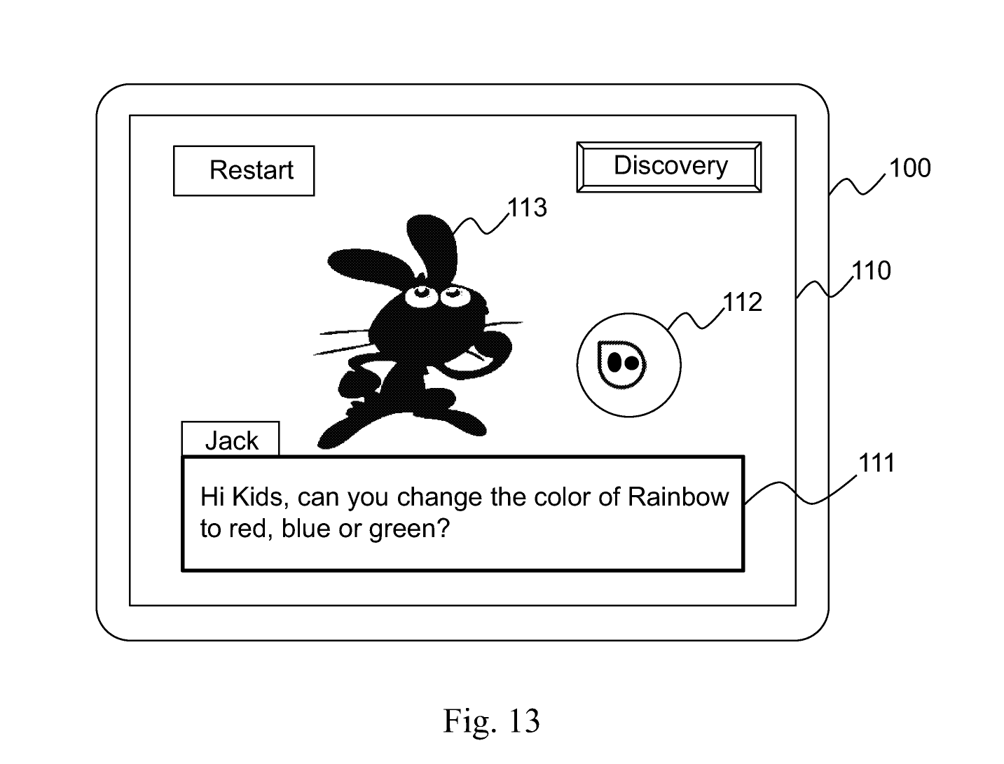

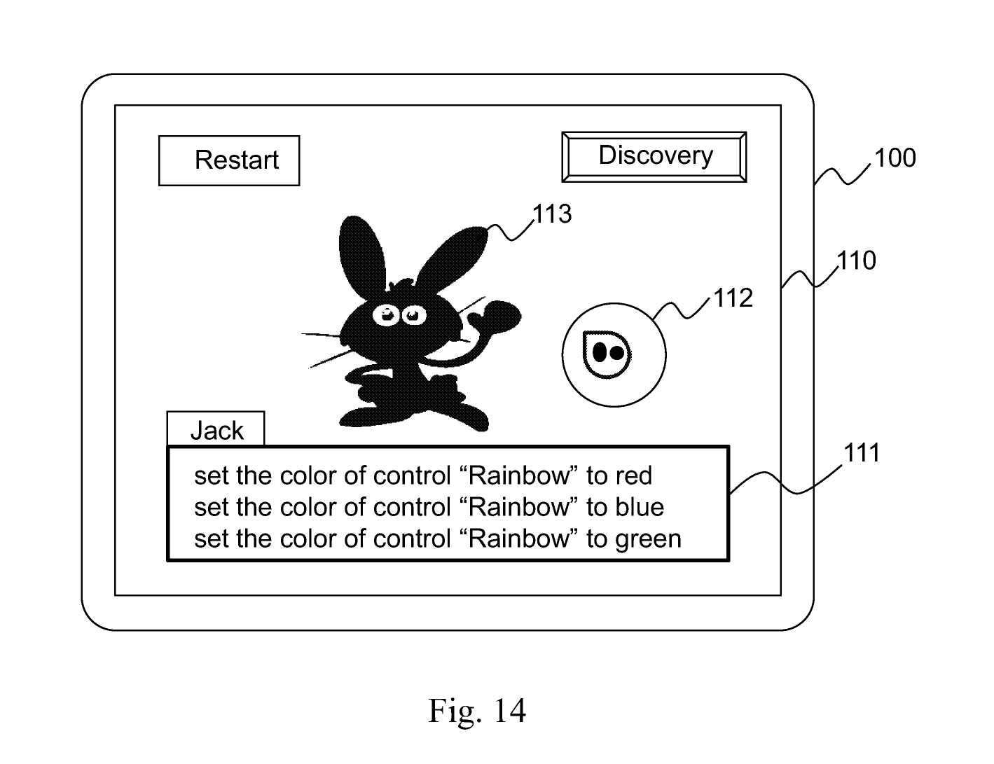

About the details of the present invention, there are some key points listed below should be emphasized. First, the virtual object 112 may be a single image of the physical object 200, it can also be successively captured images (or a film) of the physical object 200. It is not to emphasize that appearances should be matched. The virtual object 112 may be a single schematic image successively schematic images. Secondly, the description of the modification in step S02 is a textual explanation for the codes modifying the virtual object characteristic. About this point, FIG. 13 and FIG. 14 are used for illustration. FIG. 13 is corresponding to FIG. 3. The description of the modification is to enumerate all changeable colors. FIG. 14 shows corresponding codes. Of course, the description of the modification is not limited to only one single item or all items. Arbitrarily enumerate the items the developer wanted the learner to learn can also be applied by the present invention. Last, the interactive message frame 111 is able to let the learner to be familiar with a specific syntax, word and parameter with repeated practices. It makes those who don't use English as the native language to know and memorize the specific vocabularies or strings used in programming gradually. It is another reward from learning programming.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A situational programming teaching method, comprising steps of:
A. providing an interactive message frame and a virtual object on a screen of an electronic device, wherein the virtual object has a virtual object characteristic which is capable of being modified;
B. showing a description of a modification of the virtual object characteristic in the interactive message frame, wherein the modification will be taught later;
C. showing codes for modifying the virtual object characteristic in the interactive message frame;
D. showing the modification of the virtual object characteristic by the virtual object; and
E. showing all or partial codes for modifying the virtual object characteristic in the interactive message frame for learners' further modification.

2. The method according to claim 1, further comprising a step: F. showing the further modification of the virtual object characteristic by the virtual object.

3. The method according to claim 1, further comprising a step A1 after the step A and a step F1 after the step E:
A1. providing a physical object, wherein the physical object is independent from the electronic device, wirelessly linked to the electronic device and controlled by the electronic device, and has a physical object characteristic corresponding to the virtual object characteristic; and
F1. showing changes of the physical object characteristic corresponding to the further modification of the virtual object characteristic by the physical object.

4. The method according to claim 1, wherein the electronic device is a laptop computer, a tablet or a smartphone.

5. The method according to claim 1, wherein the virtual object is a single image of the physical object, successively captured images of the physical object, a single schematic image, or successively schematic images.

6. The method according to claim 1, wherein the modification description is a textual explanation for codes modifying corresponding virtual object characteristic.

7. The method according to claim 1, wherein a situational guiding object is further provided in the step A.

8. The method according to claim 7, wherein the situational guiding object shows a display aspect and changes to another display aspect as a message shown in the interactive message frame changes.

9. The method according to claim 8, wherein the display aspect is a single schematic image or successively schematic images.

10. A situational programming teaching computer program product, installed in an electronic device having a screen, executing for carrying out the method according to any one of claims 1-9.
